(19) United States
(12) Patent Application Publication
(10) Pub. No.: US 2003/0100446 A1
(43) Pub. Date: May 29, 2003

(54) Ceramic catalyst body

(76) Inventors: Tomomi Hase, Kariya-city (JP); Minoru Ota, Okazaki-city (JP); Takumi Suzawa, Okazaki-city (JP); Jun Hasegawa, Hekinan-city (JP); Kazuhiko Koike, Okazaki-city (JP)

Correspondence Address: Nixon & Vanderhye P.C., 8th Floor, 1100 North Glebe Road, Arlington, VA, 22201-4714, US

(21) Appl. No.: 10/303,706

(22) Filed: Nov. 26, 2002

(30) Foreign Application Priority Data
Nov. 29, 2001 (JP) 2001-363842

(51) Int. Cl. B01J 23/10

(52) U.S. Cl. 502/302; 502/304; 502/325

(57) ABSTRACT

In a catalyst body using a direct support, this invention provides a ceramic catalyst body capable of preventing degradation resulting from aggregation of catalyst components, excellent in low thermal capacity and low pressure loss and having excellent catalytic performance and high durability. Catalyst particles prepared by supporting a catalyst metal such as Pt on intermediate substrate particles and an assistant catalyst of a metal oxide such as CeO₂ are directly supported on a ceramic support using cordierite, a part of constituent elements of which is replaced, as a substrate and capable of directly supporting the catalyst components on replacing elements so introduced. Even when the CeO₂ particles having low bonding strength move, the catalyst metal such as Pt is prevented from moving and aggregating because it is bonded to the intermediate substrate particles, and catalyst performance can be maintained for a long time.

### BACKGROUND OF THE INVENTION

1. Field of the Invention

This invention relates to a ceramic catalyst body applied to an exhaust gas purification catalyst of an automobile engine.

2. Description of the Related Art

A variety of catalysts have been proposed in the past to purify detrimental substances emitted from automobile engines. An exhaust gas purification catalyst generally uses a cordierite honeycomb structure, having high heat and impact resistance, as a support. After a coating layer of a material having a high specific surface area such as γ-alumina is formed on a surface of the support, a catalyst precious metal and an assistant catalyst component are supported. The reason why the coating layer is formed is because cordierite has a small specific surface area. The surface area of the support is increased by use of γ-alumina, or the like, and a necessary amount of the catalyst components is supported.

However, the formation of the coating layer invites the increase of a thermal capacity of the support and is not advantageous for early activation of the catalyst. In addition, an open area becomes small and a pressure loss increases. Therefore, methods for increasing the specific surface area of cordierite itself have been examined in recent years. Japanese Examined Patent Publication (Kokoku) No. 5-50338 describes a method that eliminates the coating layer by conducting first an acid treatment and then heat-treatment to cause elution of a part of the cordierite constituent components. However, this method is yet not free from the problem that a crystal lattice of cordierite is destroyed through the acid treatment and the heat-treatment, and the strength drops. Therefore, this method has low utility.

In contrast, the inventors of this invention have previously proposed a ceramic support capable of directly supporting a necessary amount of catalyst components without forming the coating layer to improve the specific surface area (Japanese Patent Application No. 2000-104994). In this ceramic support, at least one kind of constituent elements of a ceramic substrate is replaced by an element having different valence, and a large number of fine pores consisting of lattice defect inside a crystal lattice are formed on the surface of the ceramic substrate. Since these fine pores are extremely small, they can directly support a necessary amount of the catalyst components without inviting the problem of the drop of the strength that has been observed in the catalyst bodies of the prior art.

Besides the catalyst precious metal such as Pt as the main catalyst, various assistant catalysts are generally supported depending on the application in the exhaust gas purification catalyst. It has been clarified, however, that when these catalyst components are supported on the ceramic support capable of directly supporting them without using the coating layer, the catalyst precious metal aggregates in the course of the use of the catalyst for a long time depending on the combination of the catalysts to thereby invite the increase of the particle diameter, and catalyst performance drops. A metal oxide of CeO₂, for example, is added to a three way catalyst and an NOx catalyst. It is believed that as the assistant catalyst particles such as CeO₂ having a large particle diameter move round on the ceramic substrate, bonds of the catalyst precious metal such as Pt with the ceramic substrate are cut off, and degradation is likely to occur.

### SUMMARY OF THE INVENTION

It is therefore an object of the invention to provide a ceramic catalyst body that suppresses degradation resulting from the movement of catalyst components, makes most of the advantages of a ceramic support having low thermal capacity and low pressure loss brought forth by the absence of a coating layer, exhibits high performance and has high durability.

The invention provides a ceramic catalyst body in which a ceramic support supports catalyst components. The ceramic support is one that can directly support the catalyst components on a surface of a ceramic substrate. At least a part of the catalyst components is directly supported on the ceramic support as the catalyst particles supporting the catalyst components on intermediate substrate particles.

In the construction described above, the ceramic support is the direct support. Therefore, the coating layer is not necessary and low thermal capacity and low pressure loss can be achieved. At least a part of the catalyst components such as the catalyst precious metal having a small particle diameter is directly supported as the catalyst particles supported on the intermediate substrate particles. Therefore, even when the assistant catalyst components having a large diameter move, the catalyst precious metal is prevented from being affected by the movement and from aggregation and degradation. As the intermediate substrate particles are used, the catalyst support area becomes greater and the catalyst support amount can be increased. In consequence, a ceramic catalyst body capable of keeping high catalyst performance and high utility can be acquired.

A metal oxide, for example, can be used appropriately for the intermediate substrate. When the intermediate substrate contains one or more kinds of transition metal elements, the intermediate substrate is more likely to combine with the catalyst components to be supported thereon. The transition metal elements can replace at least a part of the substrate constituent elements of the intermediate substrate. When the transition metal elements and the catalyst components are bonded with one another, the effect of suppressing degradation of the catalyst components is high. A material containing cordierite prepared by replacing a Si, Al or Mg site by the transition metal elements can be used by way of example.

The transition metal elements contained in the intermediate substrate are preferably one or more kinds of elements selected from the group consisting of Ca, Ti, Cr, Mn, Fe, Co, Ni, Cu, Zn, Ga, Ge, Sr, Y, Zr, Nb, Mo, In, Sn, Ba, La, Ce, Pr, Nd, Hf, Ta and W.

The intermediate substrate can use a prevoskite type oxide having a perovskite type crystal structure expressed by the following general formula:

(A₁)₍ₐ₋ₓ₎.(A₂)ₓ.B.O_{b}

where A₁ is at least two kinds of elements of La, Ce, Pr and Nd, A₂ is a monovalent or divalent cation, B is a transition metal element having an element number of 22 to 30, 40 to 51 and 73 to 80, when a=1, b=3 and when a=2, b=4, and 0≦x≦0.7.

In this case, too, the transition metal elements contained in the composition of the perovskite type oxide as the intermediate substrate firmly combine with the catalyst components, and degradation can be suppressed.

The particle diameter of the intermediate substrate particles is at least 1 nm and is greater than a particle diameter of the catalyst components to be supported. As the particle diameter of the catalyst components supported is generally 1 nm or above, the intermediate substrate particles greater than this particle diameter can reliably hold the catalyst components. The intermediate substrate particles may have a spherical shape, a hexahedral shape, a tetrahedral shape, a concavo-convex shape, a shape having protrusions, a needle shape, a flat sheet shape, a hexagonal prismatic shape or a tube shape.

Preferably, only the intermediate substrate particles are substantially and directly supported on the surface of the ceramic substrate in the present invention. The intermediate substrate particles are preferably supported on the ceramic surface through chemical bonds.

When the catalyst components contain the metal component and the metal oxide component, the catalyst components are preferably ones in which the metal component having a smaller diameter is supported on the intermediate substrate particles. The metal oxide component having a greater particle diameter is directly supported on the ceramic support. Even when the metal oxide component having low adsorption force with the ceramic support moves at this time, the metal component bonded to the intermediate substrate particles does not move, and degradation can be suppressed, consequently.

The ceramic support has a large number of fine pores capable of directly supporting the catalyst on the surface of the ceramic substrate, and the catalyst component can be directly supported in the fine pores. In consequence, it is possible to acquire the catalyst body in which the catalyst component is directly supported on the ceramic support without using the coating layer.

The fine pore is concretely at least one kind of defect inside a ceramic crystal lattice, fine crack on a ceramic surface and defect of elements constituting the ceramic.

When a width of the fine crack is not greater than 100 nm, the strength of the support can be desirably secured.

To support the catalyst components, the fine pore preferably has a diameter or width not greater than 1,000 times the diameter of a catalyst ion to be supported, and the number of the fine pores is at least 1×10¹¹/L. Under this condition, the same amount of the catalyst components as that of the prior art can be supported.

In the ceramic support described above, one or more kinds of elements constituting the ceramic substrate of the ceramic support are replaced by elements other than the constituent elements, and the catalyst component can be directly supported by the replacing elements.

In this case, the catalyst component is preferably supported on the replacing elements through chemical bonds. As the catalyst components are chemically bonded, retainability can be improved. As the catalyst components are uniformly dispersed in the support and hardly aggregate, degradation in the course of use for a long time is small.

The replacing element described above is preferably one or more kinds of elements having a d or f orbit in an electron orbit thereof. The element having the d or f orbit in its electron orbit is preferred because it readily combines with the catalyst component.

The ceramic support described above preferably contains cordierite as a component thereof. When cordierite is used, heat and impact resistance can be improved.

### BRIEF DESCRIPTION OF THE DRAWINGS

FIG. 1(a) is an overall schematic structural view of a ceramic catalyst body according to the invention;

FIG. 1(b) is a schematic view showing a crystal structure of a perovskite type oxide;

FIG. 2(a) is a schematic view showing a state where a ceramic support directly supports a main catalyst;

FIG. 2(b) is a schematic view showing a state where a ceramic support directly supports catalyst particles prepared by supporting a main catalyst on intermediate substrate particles;

FIGS. 3(a) to 3(c) are explanatory views useful for explaining a production method of a ceramic catalyst body according to the invention;

FIG. 4 is a schematic view showing a state where intermediate substrate particles are directly supported on a ceramic substrate of a ceramic support;

FIG. 5(a) is a schematic view showing a state where a coating layer of γ-alumina, or the like, is formed on a surface of a ceramic substrate;

FIG. 5(b) is a schematic view showing a condition where intermediate substrate particles are supported on a surface of a ceramic substrate; and

FIG. 6 is a graph comparatively showing NOx purification performance of a ceramic catalyst body directly supporting a main catalyst on a ceramic support and NOx purification performance of a ceramic catalyst body of the invention in which catalyst particles supporting a main catalyst on intermediate substrate particles are directly supported on a ceramic support.

### DESCRIPTION OF THE PREFERRED EMBODIMENTS

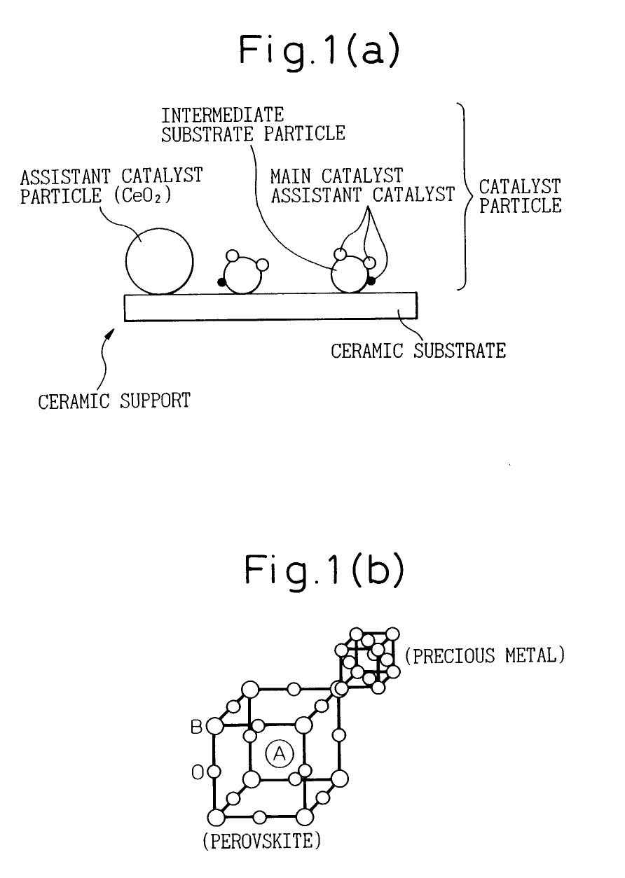

The invention will be explained hereinafter in detail with reference to the accompanying drawings. FIG. 1(a) shows a schematic construction of a ceramic catalyst body according to the invention. A ceramic support supports catalyst particles and assistant catalyst particles as catalyst components. The ceramic support is a support that can directly support the catalyst component on a surface of a ceramic substrate. The ceramic support directly supports the catalyst particles and the assistant catalyst particles as the catalyst components without using a coating layer. The support form of the catalyst particles and the assistant catalyst particles constitutes the characterizing part of the invention and will be described later in detail. The ceramic catalyst body according to the invention does not require the coating layer, and can reduce a heat capacity and a pressure loss. This ceramic catalyst body can be therefore used suitably for an exhaust gas purification catalyst for automobiles.

The ceramic substrate of the ceramic support is suitably one which consists of cordierite the theoretical composition of which is expressed by 2MgO.2Al₂O₃.5SiO₂. When the ceramic support is used for the automobile catalyst, the ceramic substrate is generally shaped into a honeycomb structure having a large number of flow passages in a gas flowing direction and is then sintered to give the ceramic support. Having high heat resistance, cordierite is suitable for the automobile catalyst used under a high temperature condition. However, the ceramic substrate can use ceramics other than cordierite, such as alumina, spinel, aluminum titanate, silicon carbide, mullite, silica-alumina, zeolite, zirconia, silicon nitride and zirconium phosphate. The support shape is not particularly limited to the honeycomb shape but may be other shapes such as pellet, powder, foam, hollow fiber, fiber, and so forth.

To directly support the catalyst components, the ceramic support has on its ceramic substrate surface a large number of fine pores capable of directly supporting the catalyst components, or contains a large number of replacing elements capable of directly supporting the catalyst components. Since the fine pores or the replacing elements directly support the catalyst components, the catalyst support can be supported without forming a coating layer having a high specific surface area such as γ-alumina.

First, the ceramic support having on the ceramic substrate surface a large number of fine pores capable of directly supporting the catalyst components will be explained. The fine pores concretely consist of at least one kind of defects (oxygen defect or lattice defect) in the ceramic crystal lattice, fine cracks on the ceramic surface and defects of the elements constituting the ceramic. At least one kind of these defects may well be formed in the ceramic support, and a plurality of kinds may be formed in combination.

The diameter of the catalyst component ion supported hereby is generally about 0.1 nm. Therefore, when the fine pores formed in the cordierite surface have a diameter or width of at least 0.1 nm, they can support the catalyst component ion. To secure the strength of the ceramic, the diameter or width of the fine pores is not greater than 1,000 times (100 nm) the diameter of the catalyst component ion and is preferably as small as possible. To hold the catalyst component ion, the depth of the fine pores is preferably at least one half of (0.05 nm) the diameter. To support an equivalent amount of the catalyst component (1.5 g/L) to that of the prior art catalyts, the number of fine pores is at least 1×10¹¹/L, preferably at least 1×10¹⁶/L and more preferably at least 1×10¹⁷/L.

Of the defects forming the fine pores in the ceramic surface, the defect of the crystal lattice includes an oxygen defect and a lattice defect (metal vacancy lattice point and lattice strain). The oxygen defect develops due to deficiency of oxygen constituting the ceramic crystal lattice. The fine pores formed due to fall-off of oxygen can support the catalyst components. The lattice defect develops when oxygen is entrapped in an amount greater than the necessary amount for forming the ceramic crystal lattice. The fine pores formed by the strain of the crystal lattice and the metal vacancy lattice point can support the catalyst components.

The number of fine pores of the ceramic support exceeds the predetermined number described above when the cordierite honeycomb structure contains at least 4×10⁻⁶%, preferably at least 4×10⁻⁵%, of a cordierite crystal having in a unit crystal lattice at least one kind of the oxygen defect and the lattice defect, or at least 4×10⁻⁸, preferably at least 4×10⁻⁷, of at least one kind of the oxygen defect and the lattice defect in the unit crystal lattice of cordierite. Next, the detail of the fine pores and a formation method will be explained.

To create the oxygen defect in the crystal lattice, the following three methods can be employed in a process for shaping a cordierite material containing an Si source, an Al source and an Mg source, including the steps of degreasing and then sintering the material as described in Japanese Patent Application No. 2000-104994: (1) a sintering atmosphere is set to a reduced pressure or reducing atmosphere, (2) a compound not containing oxygen is used as at least a part of the material, and sintering is conducted in a low oxygen concentration atmosphere so as to render oxygen in the sintering atmosphere or in the starting material deficient and (3) at least one kind of the constituent elements of the ceramic other than oxygen is replaced by use of an element having smaller valence than that of the constituent element. In the case of cordierite, the constituent elements have positive charge, that is, Si (4+), Al (3+) and Mg (2+). Therefore, when these elements are replaced by use of elements having smaller valence, the positive charge corresponding to the difference of valence of the replaced elements and to the replacing amount becomes deficient, and oxygen O (2−) having the negative charge is emitted to keep electrical neutrality as the crystal lattice, thereby creating the oxygen defect.

The crystal defect can be created by (4) replacing a part of the ceramic constituent elements other than oxygen by use of an element or elements having greater valence than the constituent elements. When a part of Si, Al and Mg as the constituent elements of cordierite is replaced by an element having greater valence than the constituent element, the positive charge corresponding to the difference of valence with the replaced element and to the replacing amount becomes excessive, and a necessary amount of O (2−) having the negative charge is entrapped to keep electrical neutrality as the crystal lattice. The cordierite crystal lattice cannot be aligned in regular order as oxygen so entrapped functions as an obstacle, forming thereby the lattice strain. The sintering atmosphere in this case is an atmospheric atmosphere so that a sufficient amount of oxygen can be supplied. Alternatively, to keep electrical neutrality, a part of Si, Al and Mg is emitted to form voids. As the size of these defects is believed to be several angstroms or below, they cannot be measured as a specific surface area by an ordinary measuring method of the specific surface area such as a BET method using nitrogen molecules.

The number of the oxygen defects and that of the lattice defects have a correlation with the oxygen amount contained in cordierite. To support the necessary amount of the catalyst components described above, the oxygen amount may well be less than 47 wt % (oxygen defect) or at least 48 wt % (lattice defect). When the oxygen amount becomes less than 47 wt % due to the formation of the oxygen defect, the oxygen number contained in the unit crystal lattice of cordierite becomes smaller than 17.2 and the lattice constant of the bₒ axis of the crystal axis of cordierite becomes smaller than 16.99. When the oxygen amount exceeds 48 wt % due to the formation of the lattice defect, the oxygen number contained in the unit crystal lattice of cordierite becomes greater than 17.6, and the lattice constant of the bₒ axis of the crystal axis of cordierite becomes greater or smaller than 16.99.

Element substitution makes it possible to further obtain a ceramic support in which a large number of elements having catalyst support capability are arranged on the surface of the ceramic substrate. In this case, the elements replacing the constituent elements of the ceramic, that is, the elements replacing Si, Al and Mg as the constituent elements other than oxygen in the case of cordierite, preferably have higher bonding strength with the catalyst components to be supported than these constituent elements and can preferably support the catalyst components through the chemical bonds. Preferred examples of such replacing elements are those having a vacant orbit in the d or f orbit or having two or more oxygen states. The elements having the vacant orbit in the d or f orbit have an energy level approximate to that of the catalyst components supported. As the exchange of the electrons is readily made, the elements are likely to be bonded with the catalyst components. The elements having two oxygen states, too, provide a similar function because the exchange of the electrons is readily made.

Concrete examples of the elements having the vacant orbit in the d or f orbit include W, Ti, V, Cr, Mn, Fe, Co, Ni, Zr, Mo, Ru, Rh, Ce, Ir and Pt. At least one kind of these elements can be used. Among these elements, W, Ti, V, Cr, Mn, Fe, Co, Mo, Ru, Rh, Ce, Ir and Pt are the elements that have two or more oxygen states. Other concrete examples of the elements having two or more oxygen states are Cu, Ga, Ge, Se, Pd, Ag and Au.

When the constituent elements of the ceramic are replaced by use of these replacing elements, it is possible to employ a method that adds and kneads the starting material of the replacing element to the ceramic starting material in which a part of the materials of the constituent elements to be replaced is reduced in advance in accordance with the replacing amount. The material is shaped into a honeycomb shape, for example, is dried, and is then degreased and sintered in an atmospheric atmosphere in accordance with an ordinary method. The thickness of the cell walls of the ceramic support is generally 150 μm or below. Because the thermal capacity becomes smaller when the wall thickness becomes smaller, the cell thickness is preferably small. Alternatively, it is also possible to employ a method that reduces a part of the starting material of the constituent elements to be replaced in accordance with the replacing amount, conducts kneading, shaping and drying in a customary manner and then lets the resulting molding be impregnated with a solution containing the replacing elements. After the product is taken out from the solution, it is similarly dried and is degreased and sintered in the atmospheric atmosphere. When the method of causing the molding to be impregnated with the solution is employed, a large number of replacing elements are allowed to exist on the surface of the molding. In consequence, element substitution occurs on the surface during sintering and a solid solution is likely to develop.

The amount of the replacing elements is such that the total replacing amount is at least 0.01% to not greater than 50% of the atomic number of the constituent elements to be replaced and preferably within the range of 5 to 20%. When the replacing element has a different valence from that of the constituent element of the ceramic, the lattice defect or the oxygen defect simultaneously occurs in accordance with the difference in valence. However, these defects do not occur when a plurality of kinds of replacing elements is used and the amount is adjusted so that the sum of the oxidation numbers of the replacing elements is equal to the sum of the oxidation numbers of the constituent elements replaced. When the amount is adjusted in this way so that the change of valence does not occur as a whole, the catalyst components can be supported thorough only bonding with the replacing elements.

The catalyst components that are supported on the ceramic support generally include a precious metal such as Pt, Rh or Pd as the main catalyst and various assistant catalysts are added whenever necessary. Examples of the assistant catalysts include lanthanoids such as La and Ce, transition metal elements such as Sc, Y, Cr, Mn, Fe, Co, Ni, Cu, Zr, Nb, Mo, Tc and Ru, alkali metal elements such as Na, K, Rb, Cs and Fr, and alkaline earth metal elements such as Mg, Ca, Sr, Ba and Ra. One or more kinds of these metal elements or their oxides or composite oxides can be used in accordance with the intended application. A catalyst using CeO₂ as the assistant catalyst component, for example, is effective as an Nox catalyst. It causes CO in the exhaust gas to react with H₂O to form H₂ and CO₂, and reduces and purifies NOx by use of H₂ so formed. An oxide prepared by replacing Ce of CeO₂ by Zr has a similar operation. Further, assistant catalyst components having various operations such as oxygen storage function, degradation suppression function, and so forth, can be added.

It is one of the features of the invention that when the catalyst components are supported on the ceramic support, at least a part of the catalyst components is supported as catalyst particles supporting the catalyst components on intermediate substrate particles. The catalyst components to be supported on the intermediate substrate particles generally have a small catalyst particle diameter. When they are directly supported as such, bonding with the ceramic substrate is likely to be cut off due to the movement of the assistant catalyst particles having a greater catalyst particle diameter. In FIG. 1(a), for example, the catalyst particle comprises the intermediate substrate particle supporting thereon the catalyst precious metal as the main catalyst and the assistant catalyst, which has a capacity for storing oxygen, other than the metal oxide. The assistant catalyst made of the metal oxide such as CeO₂ is not supported on the intermediate substrate particle but is directly supported as the assistant catalyst particle.

Cordierite, perovskite type oxides and other metal oxide type ceramics are suitably used as the intermediate substrate. Particularly when the intermediate substrate contains the transition metal element, bonding with the catalyst precious metal supported becomes desirably strong. When the composition does not contain the transition metal element, at least a part of the substrate constituent elements is replaced by transition metal elements. In this way, the transition metal element can be introduced. In the case of cordierite, for example, it is advisable to use replaced cordierite particles prepared by replacing Si, Al and Mg as the constituent elements other than oxygen, preferably the Si site, by the transition metal element as the intermediate substrate particles. The production of replaced cordierite can be conducted by the same method as the element substitution in the ceramic substrate of the ceramic support described already. A concrete example of the transition metal elements is at least one kind of elements selected from the group consisting of Ca, Ti, Cr, Mn, Fe, Co, Ni, Cu, Zn, Ga, Ge, Sr, Y, Zr, Nb, Mo, In, Sn, Ba, La, Ce, Pr, Nd, Hf, Ta and W. The catalyst component such as the catalyst precious metal is chemically bonded with, and supported by, the transition metal element.

It is possible to use various metal oxides other than cordierite as the intermediate substrate. Examples of such metal oxides include particles of an alumina type (γ-, θ-, α-Al₂O₃), an SiO₂.Al₂O₃ type, an SiO₂.MgO type, a zeolite type (X type, Y type, A type, ZSM-5 type), SiO₂, MgO, TiO₂, ZrO₂, Al₂O₃. ZrO₂, Al₂O₃.TiO₂, TiO₂.ZrO₂, SO4/ZrO₂, SO₄/ZrO₂.TiO₂, SO₄/ZrO₂.Al₂O₃, 6Al₂O₃.BaO, 11Al₂O₃.La₂O₃, mordenite and silica light.

Alternatively, it is possible to use a perovskite type oxide expressed by a general formula A.B.O₃ for the intermediate substrate. FIG. 1(b) shows a perovskite type crystal structure. It is specifically expressed by the general formula (A₁)₍ₐ₋ₓ₎.(A₂)ₓ.B.O_{b}, where

A₁: two or more kinds of La, Ce, Pr and Nd,

A₂: mono- or divalent cation (such as Na, K, Ca, Sr, Ba, Pb, Co and Ni),

B: transition metal element having an element number of 22 to 30, 40 to 51 or 73 to 80,

with the proviso that when a=1, b=3 and when a=2, b=4, and 0≦x≦0.7.

At this time, the transition metal element entering the B site of the perovskite type crystal is chemically bonded with the catalyst precious metal. In consequence, the intermediate substrate and the catalyst component can be firmly bonded.

The particle diameter of the intermediate substrate particles is generally at least 1 nm and is greater than the particle diameter of the catalyst component to be supported. The particle diameter of the catalyst precious metal as the main catalyst is generally at least 1 nm and not greater than 100 nm. The particles of the assistant catalyst made of the metal oxide generally have a particle diameter of at least 10 nm and not greater than 100 nm. Therefore, the particle diameter of the intermediate substrate particles is within the range of 10 to 100 nm in the same way as that of the assistant catalyst particles and is greater than the particle diameter of the catalyst component to be supported. The shape of the intermediate substrate particles is not particularly limited. It may well be a polyhedron such as a hexahedron and a tetrahedron, a concavo-convex shape, a shape having protrusions, a needle shape, a flat sheet shape, a polygonal prismatic shape such as a hexagonal prismatic shape and a tube shape besides a substantially spherical shape (semi-spherical shape). Generally, shapes other than the spherical shape have a greater specific surface area and can support a greater amount of the catalyst components to be supported.

In the ceramic catalyst body having the construction described above, the main catalyst and a part of the assistant, that have a small catalyst particle diameter, are first supported on the intermediate substrate particles through the chemical bonds so that they do not easily move. Then, the catalyst particles are directly supported on the ceramic support. Therefore, degradation resulting from the aggregation of the catalyst can be prevented. In other words, the bonding strength between the catalyst components and the ceramic substrate of the ceramic support is not uniform but varies depending on the catalyst components and on the substrate. Cordierite into which the replacing element is introduced, for example, is strongly bonded with the catalyst precious metal such as Pt, but the bonding strength with the oxide such as CeO₂ is relatively low. Therefore, when both of the precious metal such as Pt, Pd or Rh as the main catalyst and the assistant catalyst such as CeO₂ are directly supported on the ceramic substrate of the ceramic support, the main catalyst having a small particle diameter is peeled if the assistant catalyst not adsorbed such as CeO₂ moves round due to heat, inviting degradation due to the increase of the particle diameter.

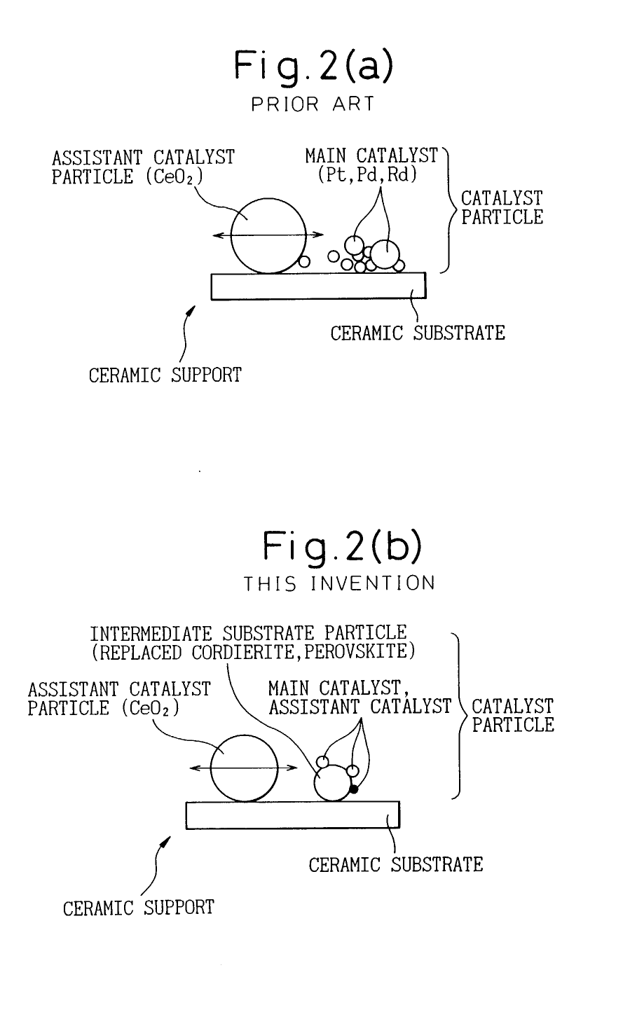

In contrast, when the precious metal as the main catalyst is supported on the intermediate substrate particles made of replaced cordierite or perovskite as shown in FIG. 2(b), the movement of the intermediate substrate particles having a relatively large particle diameter is suppressed even when the assistant catalyst particles move round. As the main catalyst and the assistant catalyst strongly bonded with the intermediate substrate particles do not move even when the intermediate substrate particles move round, aggregation of the catalyst hardly occurs, and the drop of catalyst performance can be prevented. When the ceramic support is a direct support obtained by replacing the ceramic substrate such as cordierite by W, Co or Ti at this time, replaced cordierite and perovskite as the intermediate substrate exhibit a strong bonding strength with the replacing element introduced into the support, and the effect becomes stronger.

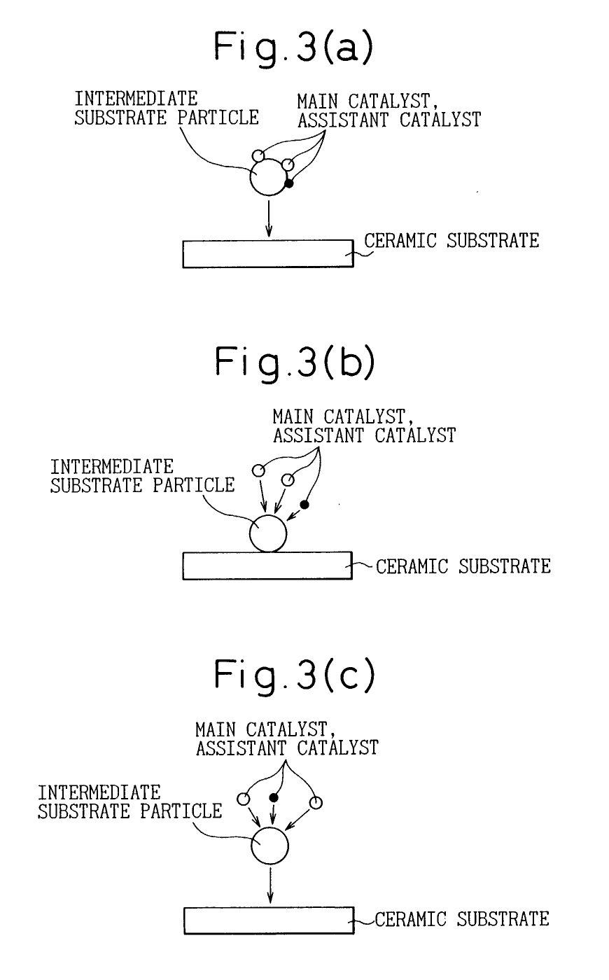

Any of the methods shown in FIGS. 3(a) to 3(c) can be employed as the method of producing the ceramic catalyst body described above. FIG. 3(a) shows the method that first supports the catalyst on the intermediate substrate particles and includes the following steps.

(1) The intermediate substrate particles in the powder form are immersed in a catalyst solution or slurry containing the catalyst (main catalyst or assistant catalyst) so as to let the intermediate substrate particles support the catalyst.

(2) After the solution or slurry is dried, the product is finely pulverized and is sintered inside a furnace (at 100 to 1,000° C.). Sintering inside the furnace is sometimes unnecessary depending on the solution.

(3) When a plurality of catalysts to be supported on the intermediate substrate particles exists, the steps described above are repeated to obtain the catalyst particles that support the catalysts (main catalyst and assistant catalyst) on the intermediate substrate particles. The catalyst solution may be sprayed in the mist formed and may be then dried to a powder form.

(4) The catalyst particles are dispersed in the solution, and the ceramic support capable of directly supporting the catalyst components in the fine pores or the replacing elements is immersed to support the catalyst particles. Next, sintering is conducted inside the furnace (at 100° C. to 1,000° C.).

FIG. 3(b) shows the method that first supports the intermediate substrate particles on the ceramic support, and includes the following steps.

(1) The intermediate substrate particles in the powder form is put and dispersed in an acid, an alkali or water, and the ceramic support is immersed to support the intermediate substrate particles.

(2) The ceramic support supporting the intermediate substrate particles is sintered inside the furnace (at 100° C. to 1,000° C.).

(3) The ceramic support is immersed in the catalyst solution containing the catalyst to let the intermediate substrate particles support the catalyst, and is then sintered inside the furnace (100 to 1,000° C.). Since the catalyst readily combines with the intermediate substrate particles, it is selectively supported by the intermediate substrate particles and forms the catalyst particles.

FIG. 3(c) shows the method that simultaneously conducts supporting of the catalyst on the intermediate substrate particles and supporting of the intermediate substrate particles on the ceramic support, and includes the following steps.

(1) The intermediate substrate particles in the powder form are dispersed in a solution or slurry containing the catalyst.

(2) When the ceramic support is immersed in this solution or slurry, it selectively forms the catalyst particles supported on the intermediate substrate particles because the catalyst readily combines with the intermediate substrate particles. The catalyst particles are supported on the ceramic support.

(3) The catalyst and the intermediate substrate particles are sintered on the ceramic support inside the furnace (100 to 1,000° C.).

When any of these methods uses the assistant catalyst made of the metal oxide, the ceramic support is immersed in the solution dispersing therein the assistant catalyst particles. Consequently, there can be obtained the catalyst particles supporting the catalyst on the intermediate substrate particles and the ceramic catalyst body directly supporting the assistant catalyst particles.

Incidentally, the main catalyst and a part of the assistant catalysts are supported on the intermediate substrate particles to form the catalyst particles in FIGS. 1(a) to 1(b) and FIGS. 2(a) to 2(b). However, it is not necessary to support both the main catalyst and the assistant catalysts on the intermediate substrate particles. When the assistant catalyst other than the metal oxide such as CeO₂ is not used, only the catalyst particles of the precious metal as the main catalyst may be supported. The construction that does not at all use the assistant catalyst component but directly supports only the catalyst particles supporting the main catalyst on the intermediate substrate particles on the ceramic support may be employed, too. According to such a construction, the effect of suppressing degradation can be acquired by use of the intermediate substrate particles having the high bonding strength with the main catalyst even when bonding is weak between the ceramic substrate of the ceramic support and the main catalyst. Even when bonding between the ceramic substrate of the ceramic support and the main catalyst is strong, too, the catalyst support area increases by use of the intermediate substrate particles, and the catalyst support amount can be increased.

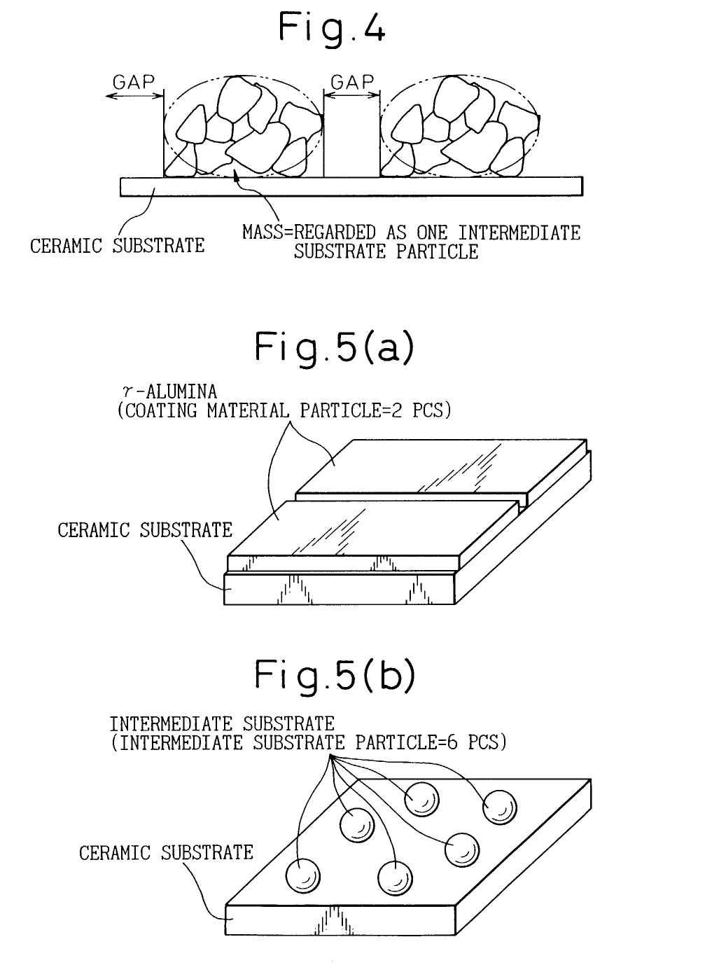

When the main catalyst having a small catalyst particle diameter is directly supported on the ceramic substrate, the main catalyst deeply enters the substrate and sometimes fails to function as the catalyst. As the intermediate substrate particles are used, however, this problem can be avoided, and a purification ratio per unit catalyst support amount can be increased. Incidentally, in the catalyst bodies according to the prior art, the coating layer of gamma-alumina, or the like, cover the entire surface of the ceramic substrate. In contrast, in the catalyst body according to the invention, the intermediate substrate in the particle form is directly supported on the fine pores or the replacing elements of the ceramic substrate, forming gaps among the intermediate substrate particles (mass formed by the aggregation of the particles having the same composition) as shown in FIG. 4. In other words, the use amount of the intermediate substrate is smaller than that of the coating layer of the gamma-alumina (1/2 or below), and the covering ratio of the ceramic substrate surface is smaller (1/2 or below), too. Therefore, the effects of low heat capacity and a low-pressure loss can be maintained. The size and thickness of the intermediate substrate particles in the invention are smaller than those of the gamma-alumina particles forming the coating layer (1/2 or below) as shown in the schematic views of FIGS. 5(a) and 5(b). Since the number of particles is greater (2 times or more) in the invention, the specific surface area and the catalyst support amount can be increased.

Next, an NOx catalyst is produced by applying the invention, and its effect is confirmed. The production method of the NOx catalyst is as follows. First, talc, kaolin, alumina and aluminum oxide as the cordierite materials and oxides (WO₃, CoO) of two kinds of elements (W, Co) having different valence for replacing 40% of the Si element are prepared in such a fashion that the resulting composition is approximate to a theoretical composition point of cordierite. After suitable amounts of a binder, a lubricant, a humidity-keeping agent and a moisture are added to the starting materials, the mixture is shaped into a honeycomb shape having a cell wall thickness of 100 μm, a cell density of 400 cpsi and a diameter of 50 mm. The honeycomb structure is sintered at 1,260° C. for 2 hours in an atmospheric atmosphere to obtain a ceramic support capable of directly supporting the catalyst components on the replacing elements (W, Co).

On the other hand, a perovskite type oxide is used for the intermediate substrate and the starting materials are prepared by a known method using a citric acid complex so as to achieve a perovskite composition expressed by the following formula:

La_{0.9}.Ce_{0.1}.Fe_{0.6}.Cu_{0.4}.O₃

After sintering, the composition is pulverized to give the intermediate substrate in the powder form (10 nm≦particle diameter≦100 nm). The intermediate substrate in the powder form is put into a catalyst solution (10 nm≦particle diameter≦100 nm) containing Pt, Pd and Rd as the main catalyst and is stirred to let the intermediate substrate particles support the main catalyst. The intermediate substrate particles taken out from the catalyst solution are pulverized to a particle diameter of 10 to 100 nm and are sintered inside a furnace (600° C.) to give the catalyst particles. The resulting catalyst particles and CeO₂ powder as the assistant catalyst are dissolved in distilled water to form slurry, and the slurry is dispersed in a solution. The direct support ceramic support prepared as described above is immersed in this solution to support the catalyst particles containing the main catalyst and the assistant catalyst particles. The support is then sintered (600° C.) to give the ceramic support body of the invention.

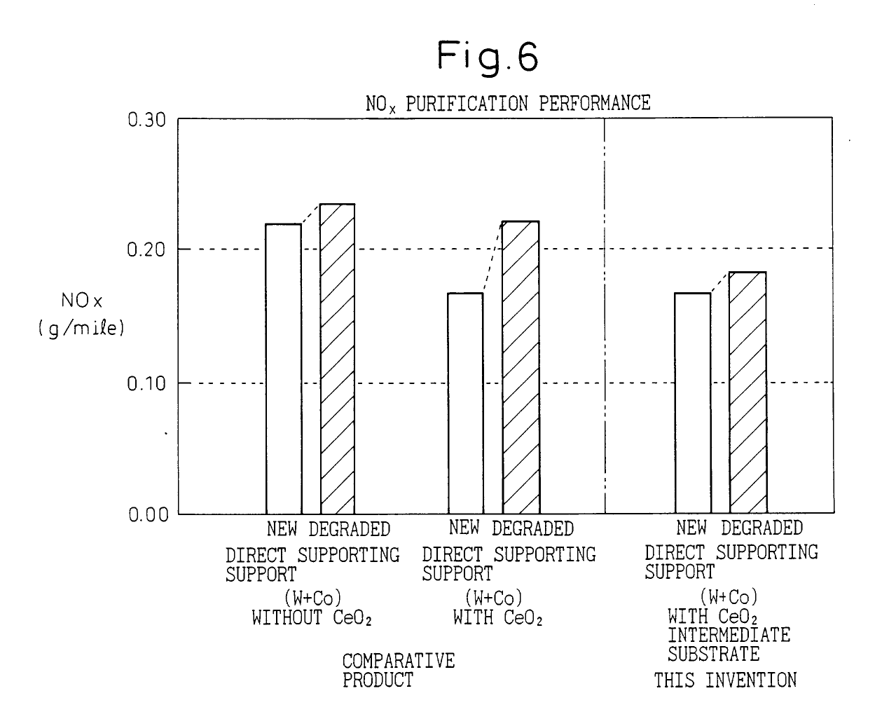

NOx purification performance of the resulting ceramic catalyst body as a new product and as a degraded product (after 24 hours' durability at 1,000° C. in an atmospheric atmosphere) is examined respectively. FIG. 6 shows the result. For comparison, FIG. 6 shows also NOx purification performance as the new product and the degraded product for the case where Pt, Pd and Rh as the main catalyst are directly supported on the direct ceramic support prepared in the same way (W, Co substitution) without using the intermediate substrate particles but CeO₂ as the assistant catalyst is not supported, and for the case where Pt, Pd and Rh as the main catalyst are directly supported without using the intermediate substrate particles and CeO₂ as the assistant catalyst is directly supported.

It can be clearly understood from the result of the comparative product shown in FIG. 6 that when CeO₂ as the assistant catalyst is not supported, the difference of NOx purification performance between the new product and the degraded product is as small as 0.01 g/mile but detected NOx attains a high value of 0.23 g/mile (after degradation). When CeO₂ as the assistant catalyst is supported, NOx of the new product exhibits a low value of 0.17 g/mile and purification performance can be drastically improved, but the difference of NOx purification performance between the new product and the degraded product increases to 0.05 g/mile on the contrary. This is presumably because the particles of CeO₂ as the assistant catalyst have a low adsorption force of the ceramic substrate of the ceramic support and peel off the main catalyst when they move round due to heat. In contrast, the ceramic catalyst body according to the invention exhibits high NOx purification performance as the new product (NOx: 0.17 g/mile) and at the same time, the difference of NOx purification performance between the new product and the degraded product decreases to 0.01 g/mile. It can thus be understood that, when the catalyst particles prepared by supporting the main catalyst on the intermediate substrate particles are used, it is possible to suppress degradation of the catalyst due to the CeO₂ particles and to maintain the purification performance of the new product for a long time.

What is claimed is:

1. A ceramic catalyst body prepared by supporting catalyst components on a ceramic support, wherein said ceramic support is a ceramic support capable of directly supporting said catalyst components on a surface of a ceramic substrate, and at least a part of said catalyst components is directly supported on said ceramic support as catalyst particles supporting said catalyst components on intermediate substrate particles.

2. A ceramic catalyst body according to claim 1, wherein said intermediate substrate is formed of a metal oxide.

3. A ceramic catalyst body according to claim 1, wherein said intermediate substrate contains at least one kind of transition metal elements.

4. A ceramic catalyst body according to claim 3, wherein said transition metal element in said intermediate substrate replaces at least a part of substrate constituent elements, and said transition metal element and said catalyst components are bonded to one another.

5. A ceramic catalyst body according to claim 3, wherein said intermediate substrate contains cordierite obtained by replacing an Si, Al or Mg site by said transition metal element as a component thereof.

6. A ceramic catalyst body according to claim 3, wherein said transition metal element is at least one kind of element selected from the group consisting of Ca, Ti, Cr, Mn, Fe, Co, Ni, Cu, Zn, Ga, Ge, Sr, Y, Zr, Nb, Mo, In, Sn, Ba, La, Ce, Pr, Nd, Hf, Ta and W.

7. A ceramic catalyst body according to claim 3, wherein said intermediate substrate has a perovskite type crystal structure expressed by the following general formula:
(A₁)₍ₐ₋ₓ₎.(A₂)ₓ.B.O_{b}
where A₁ is at least two kinds of elements of La, Ce, Pr and Nd, A₂ is a monovalent or divalent cation, B is a transition metal element having an element number of 22 to 30, 40 to 51 and 73 to 80, when a=1, b=3 and when a=2, b=4, and 0≦x≦0.7.

8. A ceramic catalyst body according to claim 1, wherein a particle diameter of said intermediate substrate is at least 1 nm and is greater than a particle diameter of said catalyst components to be supported.

9. A ceramic catalyst body according to claim 1, wherein said intermediate substrate particle has a spherical shape, a hexahedral shape, a tetrahedral shape, a concavo-convex shape, a shape having protrusions, a needle shape, a flat sheet shape, a hexagonal prismatic shape or a tube shape.

10. A ceramic catalyst body according to claim 1, wherein only said intermediate substrate particles are substantially and directly supported on a surface of said ceramic substrate.

11. A ceramic catalyst body according to claim 10, wherein said intermediate particles are supported on a ceramic surface through chemical bonds.

12. A ceramic catalyst body according to claim 1, wherein said catalyst component contains a metal component and a metal oxide component, said metal component is said catalyst component to be supported on said intermediate substrate particles, and said metal oxide component is directly supported on said ceramic support.

13. A ceramic catalyst body according to claim 1, wherein said ceramic support has a large number of fine pores capable of directly supporting a catalyst on a surface of said ceramic substrate, and a catalyst metal can be directly supported in said fine pores.

14. A ceramic catalyst body according to claim 13, wherein said fine pore is at least one kind of defect inside a ceramic crystal lattice, a fine crack on a ceramic surface and defect of elements constituting the ceramic.

15. A ceramic catalyst body according to claim 14, wherein a width of said fine crack is not greater than 100 nm.

16. A ceramic catalyst body according to claim 13, wherein said fine pore has a diameter or width not greater than 1,000 times the diameter of a catalyst ion to be supported, and the number of said fine pores is at least 1×10¹¹/L.

17. A ceramic catalyst body according to claim 1, wherein one or more kinds of elements constituting said ceramic substrate of said ceramic support are replaced by elements other than said constituent elements, and said catalyst component can be directly supported by said replacing elements.

18. A ceramic catalyst body according to claim 17, wherein said catalyst component is supported on said replacing elements through chemical bonds.

19. A ceramic catalyst body according to claim 17, wherein said replacing elements are one or more kinds of elements having a d or f orbit in an electron orbit thereof.

20. A ceramic catalyst body according to claim 1, wherein said ceramic substrate contains cordierite as a component thereof.
